(19) United States
(12) Patent Application Publication
(10) Pub. No.: US 2024/0412965 A1
(43) Pub. Date: Dec. 12, 2024

(54) MASS SPECTROMETER

(71) Applicant: SHIMADZU CORPORATION, Kyoto-shi (JP)

(72) Inventor: Yusuke SAKAGOSHI, Kyoto-shi (JP)

(21) Appl. No.: 18/699,230

(22) PCT Filed: Nov. 1, 2021
(86) PCT No.: PCT/JP2021/040214

§ 371 Date: Apr. 5, 2024

(51) Int. Cl. H01J 49/10; H01J 49/24

(52) U.S. Cl. CPC H01J 49/10; H01J 49/24

(57) ABSTRACT

A mass spectrometer 10 that introduces an ion generated in an ionization chamber 16 into a vacuum chamber 18 and detects the ion by a detector 34 includes a connection pipe 26, a connection main body portion 40, a sampling cone 50, a fixing member 52, and a locking portion 70. The connection pipe 26 allows the ionization chamber 16 and the vacuum chamber 18 to communicate with each other. The connection main body portion 40 heats the connection pipe 26 that is inserted. The sampling cone 50 is provided on the ionization chamber 16 side with respect to the connection main body portion 40, and an end portion of the connection pipe 26 is inserted through the sampling cone 50. The fixing member 52 fixes the connection pipe 26 to the connection main body portion 40. When at least one of the sampling cone 50 and the fixing member 52 is set as an object to be locked, the locking portion 70 locks the object to be locked to the connection main body portion 40. Further, one of the connection main body portion 40 and the object to be locked can be attached to and detached from the locking portion 70 provided on the other one of the connection main body portion 40 and the object to be locked.

### TECHNICAL FIELD

The present invention relates to a mass spectrometer.

### BACKGROUND ART

A mass spectrometer includes an ionization chamber that ionizes a sample and a vacuum chamber into which an ion generated in the ionization chamber is introduced (see, for example, Patent Document 1 below). The ionization chamber and the vacuum chamber are arranged adjacent to each other, and are defined by provision of a partition wall between them. An ion generated in the ionization chamber flows from the ionization chamber into the vacuum chamber through a connection pipe including a thin pipe penetrating the partition wall.

### PRIOR ART DOCUMENTS

### Patent Documents

Patent Document 1: JP 4453537 B2

### SUMMARY OF THE INVENTION

### Problems to be Solved by the Invention

In such a mass spectrometer, the connection pipe is used for desolvation. Further, an outer periphery of the connection pipe is surrounded by a connection main body portion. Furthermore, an object to be locked is locked, with a screw, to an end portion in an axial direction of the connection pipe of the connection main body portion. Examples of the object to be locked include a sampling cone and the like. The object to be locked is fixed to the connection main body portion with a screw.

At the time of maintenance of the mass spectrometer, specifically, a portion around the connection pipe, it is necessary to remove the screw with a tool in order to separate the object to be locked from the connection main body portion. Further, if an interval from previous maintenance is long, it may be difficult to remove the screw due to adhesion caused by heat or the like. That is, in a case where the object to be locked is locked to the connection main body portion with a screw, various troubles occur.

Further, there is a possibility that a person who performs maintenance drops a removed screw into the mass spectrometer and loses the screw. Furthermore, due to this, the mass spectrometer may fail.

An object of the present invention is to provide a mass spectrometer in which an object to be locked can be locked to a connection main body portion while connection and separation between the object to be locked and the connection main body portion due to displacement of the object to be locked are enabled.

### Means for Solving the Problems

A first aspect of the present invention is a mass spectrometer that introduces an ion generated by ionization of a sample in an ionization chamber into a vacuum chamber and detects the ion by a detector, the mass spectrometer including a connection pipe, a connection main body portion, a sampling cone, a fixing member, and a locking portion. The connection pipe allows the ionization chamber and the vacuum chamber to communicate with each other. The connection pipe is inserted into the connection main body portion and the connection pipe is heated. The sampling cone is provided on an ionization chamber side with respect to the connection main body portion, and has a tubular shape through which an end portion of the connection pipe is inserted. The fixing member fixes the connection pipe to the connection main body portion. When at least one of the sampling cone and the fixing member is set as an object to be locked, the locking portion locks the object to be locked to the connection main body portion. One of the connection main body portion and the object to be locked can be attached to and detached from the locking portion provided on the other of the connection main body portion and the object to be locked.

### Effects of the Invention

According to the first aspect of the present invention, it is possible to lock the object to be locked to the connection main body portion while connection and separation between the object to be locked and the connection main body portion by displacement of the object to be locked is enabled.

### BRIEF DESCRIPTION OF THE DRAWINGS

FIG. 1 is a schematic diagram illustrating an example of a mass spectrometer of a first embodiment.

FIG. 2 is a schematic cross-sectional view illustrating an example of a configuration around a connection pipe according to the first embodiment.

FIG. 3 is a schematic cross-sectional view illustrating a configuration around a first locking portion according to a variation of the first embodiment.

FIG. 4 is a schematic cross-sectional view illustrating a configuration around the first locking portion according to another variation of the first embodiment.

FIG. 5 is a schematic cross-sectional view illustrating a configuration around a second locking portion according to a variation of the first embodiment.

FIG. 6 is a schematic perspective view illustrating an example of a voltage application unit according to the first embodiment.

FIG. 7 is a schematic cross-sectional view illustrating an example of a configuration around the first locking portion of a second embodiment.

FIG. 8 is a schematic cross-sectional view illustrating an example of a configuration around the first locking portion of a third embodiment.

FIG. 9 is a schematic cross-sectional view illustrating a configuration around the first locking portion according to a variation of the third embodiment.

FIG. 10 is a schematic cross-sectional view illustrating an example of a process in which an object to be locked is locked to a connection main body portion according to another variation.

### MODE FOR CARRYING OUT THE INVENTION

### 1. Overall Configuration of Mass Spectrometer

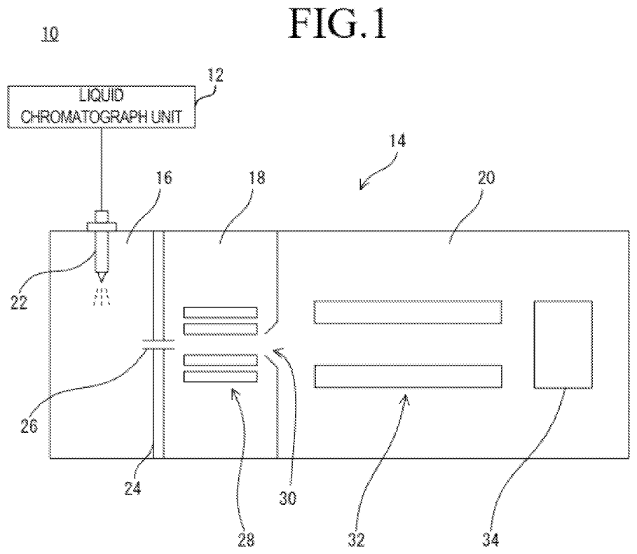

FIG. 1 is a schematic diagram illustrating an example of a mass spectrometer 10 of a first embodiment. The mass spectrometer 10 illustrated in FIG. 1 is a liquid chromatograph mass spectrometer that performs mass spectrometry on a component in a sample separated by liquid chromatography. The mass spectrometer 10 includes a liquid chromatograph unit 12 and a mass spectrometry unit 14. Note that the present invention is also applicable to a mass spectrometer other than a liquid chromatograph mass spectrometer.

The liquid chromatograph unit 12 includes a column (not illustrated). During analysis, a mobile phase containing an organic solvent such as, for example, acetonitrile or methanol is introduced into the column. A predetermined amount of sample is injected into the mobile phase introduced into the column. The mobile phase into which a sample is injected is introduced into the column, and components in the sample are separated in a process of passing through the column. Each component in the sample separated in the column is sequentially supplied to the mass spectrometry unit 14.

In the mass spectrometry unit 14, an ionization chamber 16, a vacuum chamber 18, and an analysis chamber 20 are formed. The inside of the ionization chamber 16 is substantially at atmospheric pressure. The vacuum chamber 18 and the analysis chamber 20 are brought into a vacuum state by driving of a vacuum pump (not illustrated).

The ionization chamber 16 and the vacuum chamber 18 communicate with each other, and the analysis chamber 20 and the vacuum chamber 18 communicate with each other. That is, the ionization chamber 16 communicates with the analysis chamber 20 via the vacuum chamber 18. The ionization chamber 16, the vacuum chamber 18, and the analysis chamber 20 are configured have degrees of vacuum that increase stepwise in this order.

The ionization chamber 16 is provided with a probe 22. The probe 22 sprays a liquid sample by, for example, the electrospray ionization (ESI) method. In the probe 22, a sample is charged as a charge is applied to the sample, and an ion derived from each component in the sample is generated. As described above, in the ionization chamber 16, a sample supplied from the liquid chromatograph unit 12 is ionized.

The ionization chamber 16 and the vacuum chamber 18 are defined by a partition wall 24, and a connection pipe 26 penetrates through the partition wall 24. That is, the connection pipe 26 allows the ionization chamber 16 and the vacuum chamber 18 to communicate with each other. The connection pipe 26 is formed of a thin pipe and is used for desolvation.

Further, the vacuum chamber 18 is provided with an ion guide 28 for sending ions to the analysis chamber 20 while converging the ions. Note that the vacuum chamber 18 communicating with the ionization chamber 16 may be configured in multiple stages.

The analysis chamber 20 communicates with the vacuum chamber 18 via a skimmer 30 including a small hole. An ion generated in the ionization chamber 16 is introduced into the vacuum chamber 18 via the connecting pipe 26, and then flows into the analysis chamber 20 through the skimmer 30.

The analysis chamber 20 is provided with, for example, a quadrupole filter 32 and a detector 34. Ions flowing from the vacuum chamber 18 into the analysis chamber 20 are separated according to a mass-to-charge ratio by the quadrupole filter 32 and only an ion having a specific mass-to-charge ratio pass through the quadrupole filter 32. An ion passing through the quadrupole filter 32 is incident on the detector 34. In the detector 34, current corresponding to the number of reaching ions is output as a detection signal.

According to the mass spectrometer 10, an ion generated by ionizing a sample in the ionization chamber 16 is introduced into the vacuum chamber 18, and the ion can be detected by the detector 34.

### 2. Configuration Around Connection Pipe

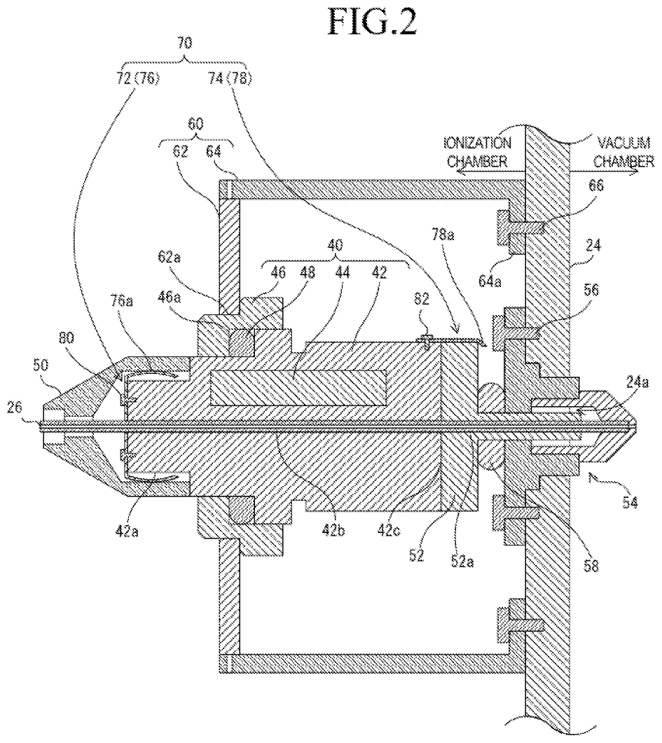

FIG. 2 is a schematic cross-sectional view illustrating an example of a configuration around the connection pipe 26 according to the first embodiment. The connection pipe 26 is formed of metal having electrical conductivity and thermal conductivity, and the connection pipe 26 is inserted into a connection main body portion 40 and the like as illustrated in FIG. 2.

The connection main body portion 40 is provided to heat the connection pipe 26 and surrounds an outer periphery of the connection pipe 26. The connection main body portion 40 includes a heating block 42, a heater 44, a flange member 46, a seal member 48, and the like.

The heating block 42 is formed of metal having electrical conductivity and thermal conductivity. Further, the heating block 42 includes a protruding portion 42a protruding to the ionization chamber 16 side.

Furthermore, a through hole 42b extending in a longitudinal direction is formed in the heating block 42. The connection pipe 26 is inserted into the through hole 42b so as to be in contact with an inner peripheral surface of the through hole 42b. That is, the heating block 42 surrounds an outer periphery of the connection pipe 26.

The heater 44 is in contact with the heating block 42. Heat of the heater 44 is transmitted to the connection pipe 26 via the heating block 42, so that the connection pipe 26 is heated.

From the above, the connection main body portion 40 heats the connection pipe 26 inserted into the connection main body portion 40. Note that illustration of a wiring or the like for supplying electric power to the heater 44 is omitted.

The flange member 46 has a through hole 46a whose diameter changes stepwise, and the heating block 42 is inserted so as to be in contact with an inner peripheral surface of the through hole 46a.

The seal member 48 includes, for example, an O-ring. The heating block 42 is inserted on the inner side of the seal member 48, and the outer side of the seal member 48 abuts on the inner side of the flange member 46. Further, the seal member 48 is sandwiched between the heating block 42 and the flange member 46 in an axial direction of the connection pipe 26.

The mass spectrometer 10 includes a sampling cone 50 in addition to the connection main body portion 40. The sampling cone 50 is an interface for drawing an ion on the ionization chamber 16 side into the connection pipe 26, and is formed of metal having electrical conductivity.

The sampling cone 50 is provided on the ionization chamber 16 side with respect to the connection main body portion 40. Further, the sampling cone 50 has a tubular shape, and an end portion of the connection pipe 26 is inserted through the sampling cone 50. Furthermore, the protruding portion 42a of heating block 42 is inserted on the inner side of the sampling cone 50.

Further, the mass spectrometer 10 includes a fixing member 52 for fixing the connection pipe 26 to the connection main body portion 40. The fixing member 52 is provided on the side opposite to the side where the sampling cone 50 is provided with respect to the connection main body portion 40.

The fixing member 52 is formed of metal having electrical conductivity and thermal conductivity. A through hole 52a is formed in the fixing member 52, and an end portion of the connection pipe 26 is inserted so as to be in contact with an inner peripheral surface of the through hole 52a. The fixing member 52 has its portion welded to the connection pipe 26 so as to be fixed to the connection pipe 26. Therefore, as the fixing member 52 is displaced along the axial direction of the connection pipe 26, the connection pipe 26 fixed to the fixing member 52 can be removed from the through hole 42b of the heating block 42, and maintenance can be performed.

Further, the fixing member 52 abuts on an entire end surface 42c of the heating block 42. By the above, heat generated by the heating block 42 is transmitted to the fixing member 52 in an excellent manner. Furthermore, a part of the fixing member 52 is inserted into the vacuum chamber 18 while protruding to the vacuum chamber 18 side.

Furthermore, the mass spectrometer 10 includes an orifice member 54. The orifice member 54 is an interface for introducing an ion into the vacuum chamber 18. The orifice member 54 is provided in an opening portion 24a, through which the connection pipe 26 is inserted, of the partition wall 24. The orifice member 54 is fixed to the partition wall 24 using a fixing tool 56 such as a screw.

Further, the mass spectrometer 10 includes a seal member 58 similar to the seal member 48, and the fixing member 52 is inserted on the inner side of the seal member 58. Further, the seal member 58 is sandwiched between the fixing member 52 and the orifice member 54 in the axial direction of the connection pipe 26.

Furthermore, the mass spectrometer 10 includes a pressing mechanism 60 for pressing the connection main body portion 40. The pressing mechanism 60 includes a pressing portion 62 and a fixing portion 64.

The pressing portion 62 is a plate-like member in which a through hole 62a is formed. The flange member 46 is inserted into the through hole 62a so as to be in contact with an inner peripheral surface of the through hole 62a.

In the example illustrated in FIG. 2, the pressing portion 62 presses the connection main body portion 40 via the flange member 46, and the fixing member 52 is pressed to the vacuum chamber 18 side at the same time. Further, each of the seal member 48 and the seal member 58 is elastically deformed as the connection main body portion 40 is pressed by the pressing portion 62.

The fixing portion 64 fixes the pressing portion 62 so as to hold a state where the pressing portion 62 presses the connection main body portion 40. For example, the fixing portion 64 is rotatable with respect to the pressing portion 62, and a tip portion of the fixing portion 64 is formed as a hook portion 64a. In this case, when the connection main body portion 40 is in a state of being pressed by the pressing portion 62 and, further, the fixing portion 64 is rotated, the hook portion 64a is locked to a pin 66 provided on the partition wall 24. That is, a state in which the connection main body portion 40 is pressed by the pressing portion 62 is maintained.

Note that the pressing mechanism 60 is not particularly limited as long as the pressing mechanism 60 can press the connection main body portion 40 and hold that state, as described above.

### 3. Regarding Locking Portion

In the first embodiment, the sampling cone 50 is displaced so as to enable connection and separation between the sampling cone 50 and the connection main body portion 40. Specifically, displacement of the sampling cone 50 is displacement along the axial direction of the connection pipe 26.

Further, in the first embodiment, the fixing member 52 is displaced so as to enable connection and separation between the fixing member 52 and the connection main body portion 40. Specifically, displacement of the fixing member 52 is displacement along the axial direction of the connection pipe 26.

Note that, in a case where the fixing member 52 is displaced along the axial direction of the connection pipe 26, the connection main body portion 40, the fixing member 52, and the like need to be detached from the orifice member 54 in advance.

Further, the mass spectrometer 10 of the first embodiment includes a locking portion 70 for locking at least one of the sampling cone 50 and the fixing member 52 as an object to be locked to the connection main body portion 40. In the first embodiment, both the sampling cone 50 and the fixing member 52 as objects to be locked are locked to the connection main body portion 40, but the configuration may be such that only one of the sampling cone 50 and the fixing member 52 is an object to be locked.

The locking portion 70 is provided on one of the connection main body portion 40 and the object to be locked, and the other of the connection main body portion 40 and the object to be locked is attachable to and detachable from the locking portion 70. In the first embodiment, a configuration in which the locking portion 70 is provided in the connection main body portion 40 will be described, but the locking portion 70 may be provided in the sampling cone 50 or the fixing member 52.

When the sampling cone 50 is set as an object to be locked, the locking portion 70 includes a first locking portion 72. The first locking portion 72 is provided on one of the connection main body portion 40 and the sampling cone 50. That is, the other of the connection main body portion 40 and the sampling cone 50 is attachable to and detachable from the first locking portion 72.

When the fixing member 52 is set as an object to be locked, the locking portion 70 includes a second locking portion 74. The second locking portion 74 is provided on one of the connection main body portion 40 and the fixing member 52. That is, the other of the connection main body portion 40 and the fixing member 52 is attachable to and detachable from the second locking portion 74.

That is, as illustrated in FIG. 2, when the sampling cone 50 and the fixing member 52 are set as objects to be locked, the locking portion 70 includes the first locking portion 72 and the second locking portion 74.

Further, in the first embodiment, the locking portion 70 includes a leaf spring that is an elastic member. In the example illustrated in FIG. 2, the first locking portion 72 includes a first leaf spring 76, and the second locking portion 74 includes a second leaf spring 78.

Further, in the example illustrated in FIG. 2, since the first locking portion 72 includes only the first leaf spring 76, the first locking portion 72 itself is the first leaf spring 76. The same applies to the second locking portion 74.

First, a case where the first leaf spring 76 as the first locking portion 72 is provided in the connection main body portion 40 will be described with reference to FIG. 2. The first leaf spring 76 of the first locking portion 72 is provided on the connection main body portion 40, specifically, on the protruding portion 42b of the heating block 42. The first leaf spring 76 is fixed to a surface intersecting the connection pipe 26 of the protruding portion 42b with a fixing tool 80. However, the first locking portion 72 may be provided in a portion other than the heating block 42 in the connection main body portion 40.

Further, the first leaf spring 76 includes a curved portion 76a that extends along the axial direction of the connection pipe 26 and is curved in advance in a radial direction of the connection pipe 26. In the example illustrated in FIG. 2, the curved portion 76a protrudes toward the sampling cone 50. However, the first leaf spring 76 may have a configuration of including a bent portion instead of the curved portion 76a. In this case, the bent portion may protrude toward the sampling cone 50. Further, in FIG. 2, a pair of the curved portions 76a are provided, but a configuration in which one curved portion or bent portion is provided may be employed, or a configuration in which three or more curved portions or bent portions are provided may be employed.

In a case where the sampling cone 50 is connected to the connection main body portion 40, the sampling cone 50 is attached to the first leaf spring 76. On the other hand, in a case where the sampling cone 50 is separated from the connection main body portion 40, the sampling cone 50 is detached from the first leaf spring 76.

That is, when the sampling cone 50 is displaced, the sampling cone 50 is attached to and detached from the first leaf spring 76.

Furthermore, in a case where the sampling cone 50 is connected to the connection main body portion 40 as illustrated in FIG. 2, a load is applied to the curved portion 76a of the first leaf spring 76. That is, the curved portion 76a of the first leaf spring 76 is elastically deformed. Further, the curved portion 76a of the first leaf spring 76 is pressed against the sampling cone 50 by a restoring force of the curved portion 76a. A direction in which the curved portion 76a of the first leaf spring 76 is pressed against the sampling cone 50 is a direction intersecting the axial direction of the connection pipe 26, specifically, a direction orthogonal to the axial direction of the connection pipe 26.

Therefore, in a case where the sampling cone 50 is connected to the connection main body portion 40, the sampling cone 50 is locked to the connection main body portion 40 by a frictional force between the sampling cone 50 and the first leaf spring 76.

Note that when the sampling cone 50 is separated from the connection main body portion 40, a force larger than a frictional force between the sampling cone 50 and the first leaf spring 76 needs to be applied to the sampling cone 50. The same applies to a case where the sampling cone 50 is connected to the connection main body portion 40.

Next, a case where the first leaf spring 76 as the first locking portion 72 is provided on the sampling cone 50 will be described. In this case, the first leaf spring 76 of the first locking portion 72 is provided on the inner side of the sampling cone 50, and the first locking portion 72 protrudes toward the protruding portion 42a of the heating block 42.

In a case where the sampling cone 50 is connected to the connection main body portion 40, the connection main body portion 40 is attached to the first leaf spring 76. On the other hand, in a case where the sampling cone 50 is separated from the connection main body portion 40, the connection main body portion 40 is detached from the first leaf spring 76.

That is, when the sampling cone 50 is displaced, the connection main body portion 40 is attached to or detached from the first leaf spring 76.

Further, in a case where the sampling cone 50 is connected to the connection main body portion 40, the sampling cone 50 is locked to the connection main body portion 40 by a frictional force between the connection main body portion 40 and the first leaf spring 76.

That is, when the sampling cone 50 is separated from the connection main body portion 40, a force larger than a frictional force between the connection main body portion 40 and the first leaf spring 76 needs to be applied to the sampling cone 50.

According to the first locking portion 72 of the first embodiment, that is, the first leaf spring 76, the sampling cone 50 can be locked to the connection main body portion 40 while connection and separation between the sampling cone 50 and the connection main body portion 40 can be enabled by displacement of the sampling cone 50.

Further, from the above, connection and separation between the sampling cone 50 and the connection main body portion 40 by displacement of the sampling cone 50 can be rephrased as attachment to and detachment of the sampling cone 50 from the connection main body portion 40 by the first locking portion 72.

Furthermore, the sampling cone 50, which is an object to be locked, can be attached to and detached from the connection main body portion 40 by the first locking portion 72 by being displaced along the axial direction of the connection pipe 26 without rotation.

Next, a case where the second leaf spring 78 as the second locking portion 74 is provided in the connection main body portion 40 will be described with reference to FIG. 2. The second leaf spring 78 of the second locking portion 74 is provided on the connection main body portion 40, specifically, on a side surface extending along the axial direction of the connection pipe 26 of the heating block 42. An end portion of the second leaf spring 78 is fixed to the heating block 42 with a fixing tool 82. However, the second locking portion 74 may be provided in a portion other than the heating block 42 in the connection main body portion 40.

The second leaf spring 78 includes a claw portion 78a at an end portion not fixed with the fixing tool 82. The claw portion 78a is tapered toward the connection pipe 26. Further, the claw portion 78a is inclined with respect to a plane orthogonal to the axial direction of the connection pipe 26.

In a case where the fixing member 52 is connected to the connection main body portion 40, the fixing member 52 is attached to the second leaf spring 78. On the other hand, in a case where the fixing member 52 is separated from the connection main body portion 40, the fixing member 52 is detached from the second leaf spring 78.

That is, when the fixing member 52 is displaced, the fixing member 52 is attached to and detached from the second leaf spring 78.

Furthermore, as illustrated in FIG. 2, in a case where the fixing member 52 is connected to the connection main body portion 40, the second leaf spring 78 abuts and extends on the heating block 42 and the fixing member 52. Furthermore, the claw portion 78a of the second leaf spring 78 catches the fixing member 52.

Further, in a case where the fixing member 52 is separated from the connection main body portion 40, due to an angle of the claw portion 78a of the second leaf spring 78, a load in a direction away from the fixing member 52 is applied to the claw portion 78a. That is, when the claw portion 78a of the second leaf spring 78 is displaced, the second leaf spring 78 is elastically deformed.

In a case where the fixing member 52 is connected to the connection main body portion 40 as illustrated in FIG. 2, the claw portion 78a of the second leaf spring 78 is pressed against the fixing member 52 by a restoring force of the second leaf spring 78. That is, the claw portion 78a of the second leaf spring 78 is pressed against the fixing member 52 while catching the fixing member 52.

At this time, due to an angle of the claw portion 78a, a force toward the connection main body portion 40 is applied to the fixing member 52. Therefore, the fixing member 52 is locked to the connection main body portion 40 by a force applied from the second leaf spring 78.

That is, when the fixing member 52 is separated from the connection main body portion 40, it is necessary to apply a force larger than a force applied to the fixing member 52 by the second leaf spring 78 to the fixing member 52.

Next, a case where the second leaf spring 78 as the second locking portion 74 is provided on the fixing member 52 will be described. In this case, the second leaf spring 78 of the second locking portion 74 is provided on a side surface extending along the axial direction of the connection pipe 26 of the fixing member 52. Note that, in this case, the connection main body portion 40, specifically, a side surface extending along the axial direction of the connection pipe 26 of the heating block 42 is provided with a recessed portion to be caught by the claw portion 78a.

In a case where the fixing member 52 is connected to the connection main body portion 40, the connection main body portion 40 is attached to the second leaf spring 78. On the other hand, in a case where the fixing member 52 is separated from the connection main body portion 40, the connection main body portion 40 is detached from the second leaf spring 78.

That is, when the fixing member 52 is displaced, the connection main body portion 40 is attached to or detached from the second leaf spring 78.

Further, in a case where the fixing member 52 is connected to the connection main body portion 40, the second leaf spring 78 abuts and extends on the heating block 42 and the fixing member 52. Furthermore, the claw portion 78a of the second leaf spring 78 catches a recessed portion provided on the connection main body portion 40. Further, in a case where the fixing member 52 is connected to the connection main body portion 40, the claw portion 78a of the second leaf spring 78 is pressed against the connection main body portion 40 while catching a recessed portion of the connection main body portion 40. At this time, a force toward the fixing member 52 is applied to the connection main body portion 40. Therefore, a force toward the connection main body portion 40 is applied to the fixing member 52 via the second leaf spring 78.

That is, when the fixing member 52 is separated from the connection main body portion 40, it is necessary to apply a force larger than a force applied to the fixing member 52 by the second leaf spring 78 to the fixing member 52 as described above.

According to the second locking portion 74 of the first embodiment, that is, the second leaf spring 78, the fixing member 52 can be locked to the connection main body portion 40 while connection and separation between the fixing member 52 and the connection main body portion 40 are enabled by displacement of the fixing member 52.

Further, from these, the connection and separation between the fixing member 52 and the connection main body portion 40 by displacement of the fixing member 52 can be rephrased as attachment to and detachment of the fixing member 52 from the connection main body portion 40 by the second locking portion 74.

Furthermore, the fixing member 52, which is an object to be locked, can be said to be attached to and detached from the connection main body portion 40 by the second locking portion 74 by being displaced along the axial direction of the connection pipe 26 without rotation.

Further, as will be described in detail later, in the first embodiment, a hook portion 84 for catching the locking portion 70 may be provided. When the sampling cone 50 is set as an object to be locked, the hook portion 84 includes a first hook portion 86 for catching the first locking portion 72. Further, when the fixing member 52 is set as an object to be locked, the hook portion 84 includes a second hook portion 88 for catching the second locking portion 74.

The first hook portion 86 is provided on one of the sampling cone 50 and the connection main body portion 40 different from the one provided with the first locking portion 72. Further, the first hook portion 86 is either a protruding portion or a recessed portion. The second hook portion 88 is provided on one of the fixing member 52 and the connection main body portion 40 different from the one provided with the second locking portion 74. Further, the second hook portion 88 is a recessed portion.

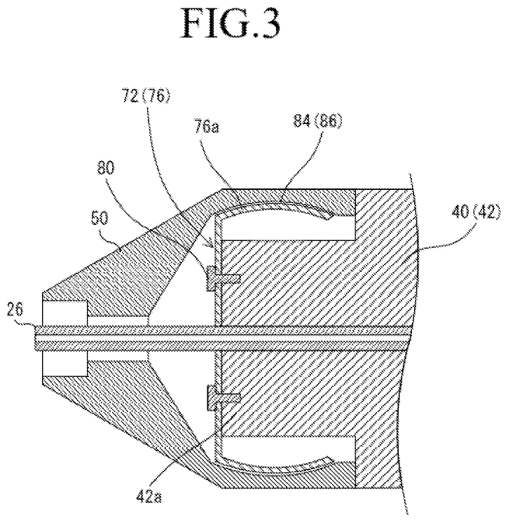

FIG. 3 is a schematic cross-sectional view illustrating a configuration around the first locking portion 72 according to a variation of the first embodiment. In the example illustrated in FIG. 3, the first locking portion 72 is the first leaf spring 76, and the first hook portion 86 is a recessed portion. In the example illustrated in FIG. 3, the curved portion 76a of the first leaf spring 76 is fitted into the first hook portion 86, so that the first leaf spring 76 is caught by the first hook portion 86. In a case where the first leaf spring 76 is configured to include a bent portion instead of the curved portion 76a, the first hook portion 86 having a recessed shape that catches the bent portion may be formed.

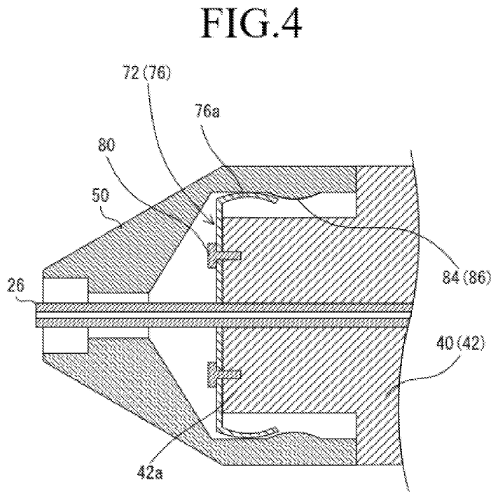

FIG. 4 is a schematic cross-sectional view illustrating a configuration around the first locking portion 72 according to another variation of the first embodiment. In the example illustrated in FIG. 4, the first locking portion 72 is the first leaf spring 76, and the first hook portion 86 is a protruding portion. In the example illustrated in FIG. 4, the curved portion 76a of the first leaf spring 76 is caught by the first hook portion 86 along with displacement of the sampling cone 50. In a case where the first leaf spring 76 is configured to include a bent portion instead of the curved portion 76a, the first hook portion 86 having a protruding portion on which the bent portion is caught may be formed.

Note that size of the first hook portion 86 is such that the sampling cone 50 can be displaced while the first leaf spring 76 is elastically deformed.

As described above, according to the first hook portion 86, the sampling cone 50 can be firmly locked to the connection main body portion 40.

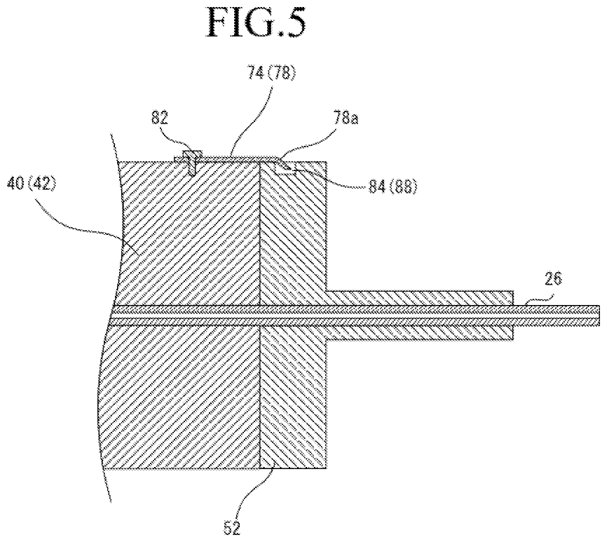

FIG. 5 is a schematic cross-sectional view illustrating a configuration around the second locking portion 74 according to a variation of the first embodiment. In the example illustrated in FIG. 5, the second locking portion 74 is the second leaf spring 78. In the example illustrated in FIG. 5, the claw portion 78a of the second leaf spring 78 is fitted into the second hook portion 88, so that the second leaf spring 78 is caught by the second hook portion 88.

Note that, as described above, in a case where the second leaf spring 78 is provided on the fixing member 52, it is necessary to provide a recessed portion to be caught by the claw portion 78a on the connection main body portion 40. This recessed portion refers to the second hook portion 88. That is, in a case where the second leaf spring 78 is provided on the fixing member 52, the second hook portion 88 is provided on the connection main body portion 40.

The mass spectrometer 10 of the first embodiment includes a voltage application unit 90 (described later). The voltage application unit 90 applies voltage to the locking portion 70 to energize the connection pipe 26 via the locking portion 70.

Therefore, in a case where voltage is applied to the first locking portion 72, the first locking portion 72 is formed of a member having electrical conductivity. Further, in a case where voltage is applied to the second locking portion 74, the second locking portion 74 is formed of a member having electrical conductivity.

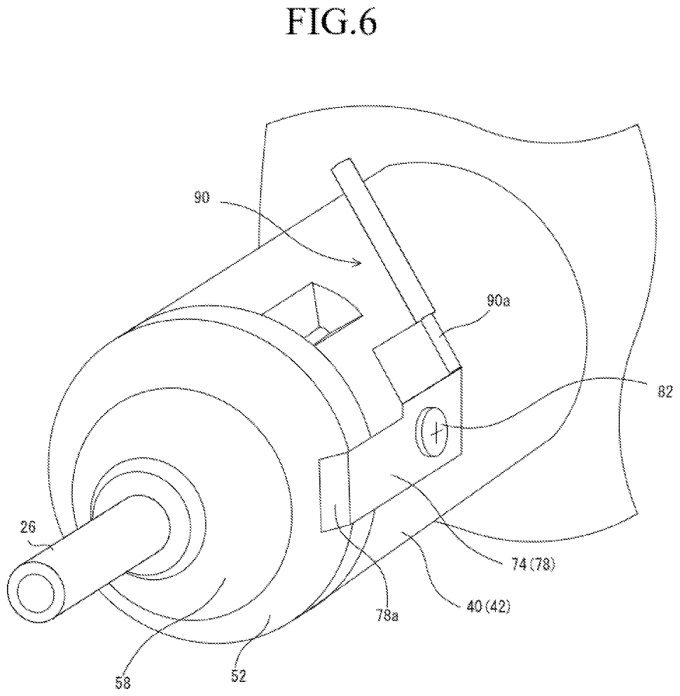

FIG. 6 is a schematic perspective view illustrating an example of the voltage application unit 90 of the first embodiment. In FIG. 6, the second leaf spring 78 which is the second locking portion 74 is provided on the connection main body portion 40. Further, in the example illustrated in FIG. 6, the voltage application unit 90 applies voltage to the second leaf spring 78. Specifically, a pin 90a made from metal included in the voltage application unit 90 is welded to the second leaf spring 78, and voltage is applied to the second leaf spring 78 via the pin 90a. Note that, although not illustrated, the voltage application unit 90 is connected to a power supply via a wiring.

As described above, the heating block 42, the sampling cone 50, and the fixing member 52 have electrical conductivity. Accordingly, when voltage is applied to the second locking portion 74, voltage is similarly applied to the heating block 42 and the like accordingly.

Further, as described above, the connection pipe 26 having electrical conductivity is inserted through the heating block 42, the sampling cone 50, and the fixing member 52. Therefore, when voltage is applied to the heating block 42 or the like, voltage is also applied to the connection pipe 26 accordingly. Note that, if voltage is applied to the first locking portion 72, voltage is applied to the connection pipe 26 as described above.

As described above, when the voltage application unit 90 energizes the connection pipe 26, an ion can be efficiently drawn into the connection pipe 26. Note that the voltage application unit 90 may apply voltage to the heating block 42, the sampling cone 50, or the fixing member 52.

### 3. Second Embodiment

A second embodiment is similar to the first embodiment except that the configuration and the like of the first locking portion 72 are changed. Therefore, description overlapping that of the first embodiment may be omitted. Note that a configuration similar to that of the second embodiment may be employed for the second locking portion 74.

As will be described in detail later, the first locking portion 72 of the second embodiment includes an elastic member 92 and a displacement member 94. The displacement member 94 is displaced along with elastic deformation of the elastic member 92. Further, the displacement member 94 is also displaced by a restoring force of the elastic member 92.

As the elastic member 92, for example, a coil spring can be used. The elastic member 92 is not particularly limited, and rubber, a leaf spring, or the like may be used.

As the displacement member 94, for example, a plate-like member is used. The displacement member 94 is not particularly limited, and a pin-shaped member or the like may be used.

In the second embodiment, when one of the connection main body portion 40 and the sampling cone 50 is attached to and detached from the first locking portion 72 provided on the other of the connection main body portion 40 and the sampling cone 50, that is, when the sampling cone 50 and the connection main body portion 40 are connected and separated, the displacement member 94 is displaced along with elastic deformation of the elastic member 92.

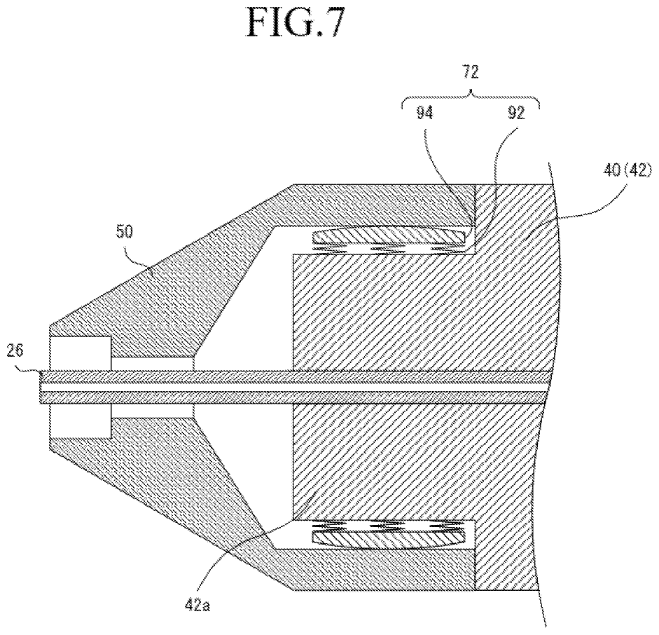

FIG. 7 is a schematic cross-sectional view illustrating an example of a configuration around the first locking portion 72 of the second embodiment. In the example illustrated in FIG. 7, the first locking portion 72 is provided on the connection main body portion 40. Further, the elastic member 92 is a coil spring, and the displacement member 94 is a plate-shaped member.

In the example illustrated in FIG. 7, the elastic member 92 is elastically deformed by being compressed. That is, the displacement member 94 is pressed against the sampling cone 50 by a restoring force of the elastic member 92. A direction in which the displacement member 94 is pressed against the sampling cone 50 is a direction intersecting the axial direction of the connection pipe 26, specifically, a direction orthogonal to the axial direction of the connection pipe 26. Therefore, in the example illustrated in FIG. 7, the sampling cone 50 is locked to the connection main body portion 40 by a frictional force between the displacement member 94 and the sampling cone 50.

When the first locking portion 72 is provided on the sampling cone 50, the displacement member 94 is pressed against the connection main body portion 40 by a restoring force of the elastic member 92. That is, the sampling cone 50 is locked to the connection main body portion 40 by a frictional force between the displacement member 94 and the connection main body portion 40.

As described above, according to the first locking portion 72 of the second embodiment, the sampling cone 50 can be locked to the connection main body portion 40 by use of the displacement member 94 which is a member different from the elastic member 92.

Note that, similarly to the first hook portion 86 in the first embodiment, a hook portion that catches the displacement member 94 may be provided on one of the sampling cone 50 and the connection main body portion 40 different from one provided with the first locking portion 72.

### 4. Third Embodiment

A third embodiment is similar to the first embodiment except that the configuration and the like of the first locking portion 72 are changed. Therefore, description overlapping that of the first embodiment may be omitted. Note that a configuration similar to that of the third embodiment may be employed for the second locking portion 74.

As will be described in detail later, in the third embodiment, the first locking portion 72 does not need to include an elastic member as in the first embodiment and the second embodiment. Further, the first locking portion 72 includes a protruding portion 72a.

Further, in the third embodiment, the first hook portion 86 is provided on one of the connection main body portion 40 and the sampling cone 50 not provided with the first locking portion 72.

Note that, in the third embodiment, size of the first hook portion 84 is such that the sampling cone 50 can be displaced when a predetermined force or more is applied to the sampling cone 50 while the first locking portion 72 is caught.

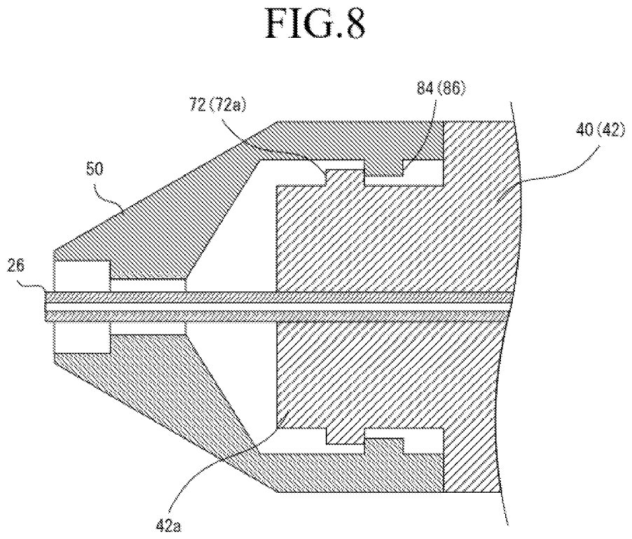

FIG. 8 is a schematic cross-sectional view illustrating an example of a configuration around the first locking portion 72 of the third embodiment. In the example illustrated in FIG. 8, the first locking portion 72 is provided on the connection main body portion 40, and the first locking portion 72 itself is the protruding portion 72a. Further, in the example illustrated in FIG. 8, the first hook portion 86 is a protruding portion.

In the example illustrated in FIG. 8, tip portions of the first locking portion 72 and the first hook portion 86 overlap each other in the axial direction of the connection pipe 26, and the first locking portion 72 is caught on the first hook portion 86 along with displacement of the sampling cone 50. That is, the sampling cone 50 is locked to the connection main body portion 40.

Further, the first hook portion 86 may be a recessed portion. Although not illustrated, in this case, the sampling cone 50 is locked to the connection main body portion 40 as the first locking portion 72 is fitted into the first hook portion 86.

In the third embodiment, in order to lock the sampling cone 50 to the connection main body portion 40, it is necessary to provide both the first locking portion 72 and the first hook portion 86. Therefore, in a case where the first hook portion 86 is a protruding portion, the first locking portion 72 may include a recessed portion 72b (described later) instead of the protruding portion 72a.

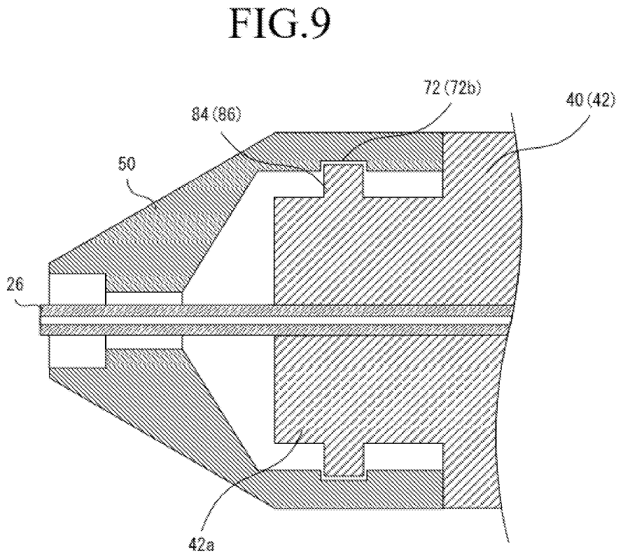

FIG. 9 is a schematic cross-sectional view illustrating a configuration around the first locking portion 72 according to a variation of the third embodiment. In the example illustrated in FIG. 9, the first locking portion 72 is provided on the sampling cone 50, and the first locking portion 72 itself is the recessed portion 72b. Further, in the example illustrated in FIG. 9, the sampling cone 50 is locked to the connection main body portion 40 as the first locking portion 72 accommodates the first hook portion 86.

From these, it can be said that the locking portion 70 of the third embodiment, specifically, the first locking portion 72 includes the protruding portion 72a or the recessed portion 72b for locking the sampling cone 50 to the connection main body portion 40.

### 5. Another Variation

As another variation, a configuration in which an object to be locked is rotated at the time of connection and separation between the object to be locked and the connection main body portion 40 can be exemplified.

In this variation, when an object to be locked is brought close to the connection main body portion 40 and then rotated, the object to be locked is locked to the connection main body portion 40. On the other hand, when an object to be locked that is locked to the connection main body portion 40 is rotated, the object to be locked can be separated from the connection main body portion 40.

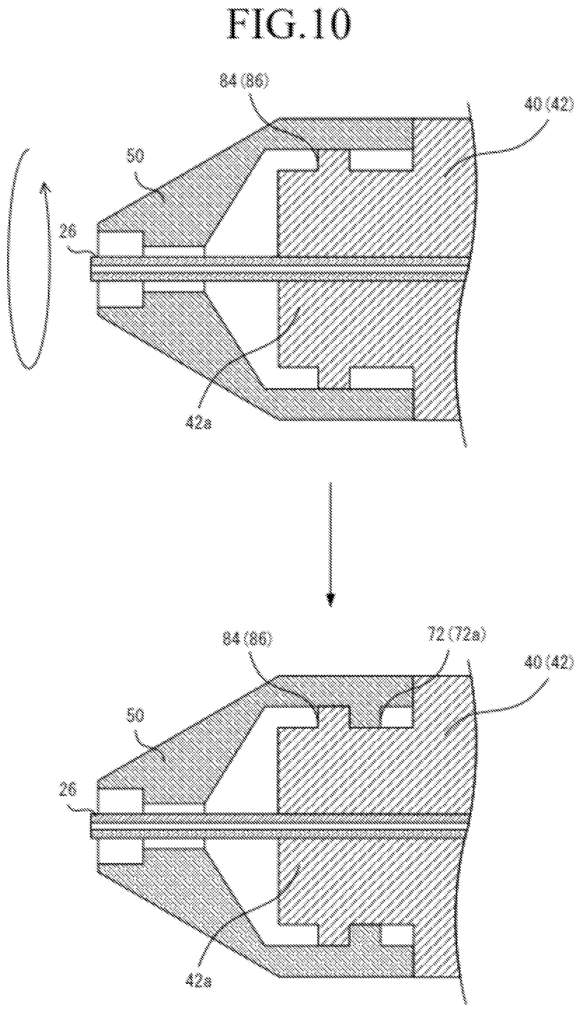

FIG. 10 is a schematic cross-sectional view illustrating an example of a process in which an object to be locked of another variation is locked to the connection main body portion 40. In the example illustrated in FIG. 10, the object to be locked is the sampling cone 50. Further, the first locking portion 72 includes the protruding portion 72a and is provided on the sampling cone 50. Furthermore, the first hook portion 86 formed of a protruding portion is provided on the connection main body portion 40, specifically, the protruding portion 42a.

As illustrated in FIG. 10, when the sampling cone 50 is connected to the connection main body portion 40, the first locking portion 72 and the first hook portion 86 do not overlap each other in the axial direction of the connection pipe 26.

When the sampling cone 50 is rotated after the protruding portion 42a is inserted into the sampling cone 50, the first locking portion 72 and the first hook portion 86 overlap each other in the axial direction of the connection pipe 26. That is, the sampling cone 50 is locked to the connection main body portion 40 as the first locking portion 72 is caught by the first hook portion 86.

Although not illustrated, in a case where the first hook portion 86 is a recessed portion, the recessed portion is a groove extending in an L shape or a T shape. In this case, when the sampling cone 50 is rotated after the protruding portion 42a is inserted into the sampling cone 50, the sampling cone 50 is locked to the connection main body portion 40.

Further, although not illustrated, the fixing member 52 may also be configured to be locked to the connection main body portion 40 by being brought close to the connection main body portion 40 and then rotated.

### 6. Aspect

It is understood by those skilled in the art that a plurality of the exemplary embodiments described above are specific examples of an aspect below.

(Clause 1) A mass spectrometer according to an aspect is a mass spectrometer that introduces an ion generated by ionization of a sample in an ionization chamber into a vacuum chamber and detects the ion by a detector, the mass spectrometer including:

a connection pipe that allows the ionization chamber and the vacuum chamber to communicate with each other;

a connection main body portion through which the connection pipe is inserted and which heats the connection pipe;

a sampling cone having a cylindrical shape through which an end portion of the connection pipe is inserted, the sampling cone being provided on an ionization chamber side with respect to the connection main body portion;

a fixing member for fixing the connection pipe to the connection main body portion; and

a locking portion for locking an object to be locked to the connection main body portion when the object to be locked is at least one of the sampling cone and the fixing member, and

one of the connection main body portion and the object to be locked may be able to be attached to and detached from the locking portion provided on another one of the connection main body portion and the object to be locked.

According to the mass spectrometer according to Clause 1, it is possible to lock the object to be locked to the connection main body portion while connection and separation between the object to be locked and the connection main body portion by displacement of the object to be locked is enabled.

(Clause 2) In the mass spectrometer according to Clause 1, the object to be locked may be able to be attached to and detached from the connection main body portion by the locking portion by being displaced along an axial direction of the connection pipe without rotation.

According to the mass spectrometer according to Clause 2, the object to be locked can be locked to the connection main body portion while being connected to the connection main body portion only by operation for displacing the object to be locked without rotation.

Further, the object to be locked can be separated from the connection main body portion only by operation for displacing the object to be locked without rotation.

(Clause 3) In the mass spectrometer according to Clause 1, the locking portion may include at least an elastic member.

According to the mass spectrometer according to Clause 3, the object to be locked can be locked to the connection main body portion by use of a restoring force of the elastic member.

(Clause 4) In the mass spectrometer according to Clause 3, the elastic member may be a leaf spring.

According to the mass spectrometer according to Clause 4, the object to be locked can be locked to the connection main body portion by use of a restoring force of the leaf spring.

(Clause 5) In the mass spectrometer according to Clause 3, the locking portion may include a displacement member that is displaced along with elastic deformation of the elastic member, and when one of the connection main body portion and the object to be locked is attached to or detached from the locking portion provided on another one of the connection main body portion and the object to be locked, the displacement member may be displaced along with elastic deformation of the elastic member.

According to the mass spectrometer according to Clause 5, it is possible to lock the object to be locked to the connection main body portion by using the displacement member which is a member different from the elastic member while using a restoring force of the elastic member.

(Clause 6) In the mass spectrometer according to Clause 1, the locking portion may include a protruding portion or a recessed portion for locking the object to be locked to the connection main body portion.

According to the mass spectrometer according to Clause 6, the object to be locked can be locked to the connection main body portion as the protruding portion or the recessed portion of the locking portion catches one that is not provided with the locking portion.

(Clause 7) In the mass spectrometer according to Clause 1, the connection main body portion may include a heater and a heating block that transfers heat from the heater to the connection pipe, and the locking portion may be provided on the heating block.

According to the mass spectrometer according to Clause 7, the object to be locked can be locked to the connection main body portion with a simple configuration in which the locking portion is provided on the heating block.

(Clause 8) The mass spectrometer according to Clause 1 may further include a voltage application unit that applies voltage to the locking portion to energize the connection pipe via the locking portion.

According to the mass spectrometer according to Clause 8, an ion can be efficiently drawn into the connection pipe.

(Clause 9) In the mass spectrometer according to Clause 1,

the locking portion may include a first locking portion and a second locking portion,

one of the connection main body portion and the sampling cone may be able to be attached to and detached from the first locking portion provided on another one of the connection main body portion and the sampling cone, and

one of the connection main body portion and the fixing member may be able to be attached to and detached from the second locking portion provided on another one of the connection main body portion and the fixing member.

According to the mass spectrometer according to Clause 9, the sampling cone can be locked to the connection main body portion while connection and separation between the sampling cone and the connection main body portion by displacement of the sampling cone is enabled. Further, the fixing member can be locked to the connection main body portion while connection and separation between the fixing member and the connection main body portion by displacement of the fixing member is enabled.

### DESCRIPTION OF REFERENCE SIGNS

10 mass spectrometer
16 ionization chamber
18 vacuum chamber
26 connection pipe
34 detector
40 connection main body portion
42 heating block
44 heater
50 sampling cone
52 fixing member
70 locking portion
72 first locking portion
72a protruding portion
72b recessed portion
74 second locking portion
76 first leaf spring
78 second leaf spring
90 voltage application unit
92 elastic member
94 displacement member

1. A mass spectrometer that introduces an ion generated by ionization of a sample in an ionization chamber into a vacuum chamber and detects the ion by a detector, the mass spectrometer comprising:
a connection pipe that allows the ionization chamber and the vacuum chamber to communicate with each other;
a connection main body portion through which the connection pipe is inserted and which heats the connection pipe;
a sampling cone having a cylindrical shape through which an end portion of the connection pipe is inserted, the sampling cone being provided on an ionization chamber side with respect to the connection main body portion;
a fixing member for fixing the connection pipe to the connection main body portion; and
a locking portion for locking an object to be locked to the connection main body portion when the object to be locked is at least one of the sampling cone and the fixing member,
wherein
one of the connection main body portion and the object to be locked can be attached to and detached from the locking portion provided on another one of the connection main body portion and the object to be locked.

2. The mass spectrometer according to claim 1, wherein the object to be locked can be attached to and detached from the connection main body portion by the locking portion by being displaced along an axial direction of the connection pipe without rotation.

3. The mass spectrometer according to claim 1, wherein the locking portion includes at least an elastic member.

4. The mass spectrometer according to claim 3, wherein the elastic member is a leaf spring.

5. The mass spectrometer according to claim 3, wherein
the locking portion includes a displacement member that is displaced along with elastic deformation of the elastic member, and
when one of the connection main body portion and the object to be locked is attached to or detached from the locking portion provided on another one of the connection main body portion and the object to be locked, the displacement member is displaced along with elastic deformation of the elastic member.

6. The mass spectrometer according to claim 1, wherein the locking portion includes a protruding portion or a recessed portion for locking the object to be locked to the connection main body portion.

7. The mass spectrometer according to claim 1, wherein
the connection main body portion includes a heater and a heating block that transfers heat from the heater to the connection pipe, and
the locking portion is provided on the heating block.

8. The mass spectrometer according to claim 1, further comprising a voltage application unit that applies voltage to the locking portion to energize the connection pipe via the locking portion.

9. The mass spectrometer according to claim 1, wherein
the locking portion includes a first locking portion and a second locking portion,
one of the connection main body portion and the sampling cone can be attached to and detached from the first locking portion provided on another one of the connection main body portion and the sampling cone, and
one of the connection main body portion and the fixing member can be attached to and detached from the second locking portion provided on another one of the connection main body portion and the fixing member.
